(19) United States
(12) Patent Application Publication
(10) Pub. No.: US 2007/0207658 A1
(43) Pub. Date: Sep. 6, 2007

(54) STRUCTURE MOUNTING DEVICE

(75) Inventors: Johnny COX, Rowlett, TX (US); Trevor JACKSON, Kirtland, OH (US); Harry Klaus, Mars, PA (US)

Correspondence Address: CALFEE HALTER & GRISWOLD, LLP, 800 SUPERIOR AVENUE, SUITE 1400, CLEVELAND, OH, 44114, US

(73) Assignee: EMERALD INNOVATIONS LLC, Butler, PA (US)

(21) Appl. No.: 11/671,312

(22) Filed: Feb. 5, 2007

Related U.S. Application Data
(60) Provisional application No. 60/764,907, filed on Feb. 3, 2006.

(51) Int. Cl. H01R 13/62

(52) U.S. Cl. 439/371

(57) ABSTRACT

The present application provides various embodiments of a mounting device having a securing means for mounting the device to a structure; a gripping means for resisting the movement of the device relative to the structure; and an attaching means for attaching decor to the structure.

### PRIORITY CLAIM

This application claims priority to and incorporates herein by reference, in its entirety, U.S. Provisional Patent Application Ser. No. 60/764,907, filed Feb. 3, 2006.

### TECHNICAL FIELD

The present application relates generally to mounting devices for mounting articles to a structure. More specifically, the present application is generally applicable to mounting devices for mounting decor articles to a structure.

### BACKGROUND OF INVENTION

A mounting device with integral or attachable mounting mechanisms that may be adapted to fasten around and grip structures of multiple shapes and sizes may be useful in a number of applications, such as, for example, supporting decor items on a lamp post, telephone pole or tree trunk, without damaging the surface of the structure with nails, staples or similar fasteners. Such a mounting device may provide adaptability by allowing a decorative article to be mounted to the structure at varying heights and in varying rotational positions around the structure; likewise, the position of such a mounted article may be easily adjusted or modified. The mounting device may also provide a strong enough grip to support larger or heavier articles.

### SUMMARY OF THE INVENTION

The present application provides various embodiments of an apparatus for mounting an article, such as, for example, a decorative ornament, lighting display, or sign, to a structure, such as, for example, a pole, tree, or lamp post. In one aspect, an apparatus is provided having a removable strap with a latching mechanism to secure the mounting device around a structure and one or more mounting members, disposed on the strap, for mounting one or more articles to the mounting device before or after the device is assembled and fastened to a structure. Alternatively, an article, such as a decor item, could be permanently affixed to an embodiment of the mounting device.

Additional features and advantages of the various embodiment will be set forth in part in the description that follows, and in part will be obvious from the description, or may be learned by practice of the embodiments. The features and advantages of the present application will be realized and attained by means of the elements and combinations particularly pointed out in the appended claims. It is to be understood that both the foregoing general description and the following detailed description are exemplary and explanatory only and are not restrictive or limiting. The accompanying drawings, which are incorporated in and constitute a pair of this specification, illustrate several embodiments, and together with the description, serve to explain the principles of the present application.

### BRIEF DESCRIPTION OF THE DRAWINGS

FIG. 1 is a top perspective view of a mounting device according to an embodiment of the present application;

FIG. 2 is a top view of the exemplary mounting device shown in FIG. 1;

FIG. 3 is a top perspective view of a mounting device according to an embodiment of the present application; and

FIG. 4 is a top view of the exemplary mounting device shown in FIG. 3;

### DETAILED DESCRIPTION OF THE INVENTION

The present application will now be described with occasional reference to specific embodiments. This application may, however, be embodied in different forms and should not be construed as limited to the embodiments set forth herein. Rather, these embodiments are provided so that this disclosure will fully convey the scope of the application to those skilled in the art.

Except as otherwise specifically defined herein, all terms used herein have the same meaning as commonly understood by one of ordinary skill in the art to which this application belongs. The terminology used in the description of the embodiments herein is for describing particular embodiments only, and is not intended to be limiting of the application. As used in the description and the appended claims, the singular forms “a,” “an,” and “the” are intended to include the plural forms as well, unless the context clearly indicates otherwise.

Except as otherwise indicated, the disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present application.

The present application is directed, in various embodiments, to an apparatus for mounting an article, such as, for example, a decorative ornament, lighting display, or sign, to a structure, such as, for example, a pole, tree, or lamp post. An exemplary embodiment of the mounting device has a securing means for mounting the device to the structure; a gripping means for resisting the movement of the device relative to the structure; and an attaching means for attaching decor to the structure. Although these three parts of the exemplary embodiment are independent, two or more of them may be combined together in a unitary construction.

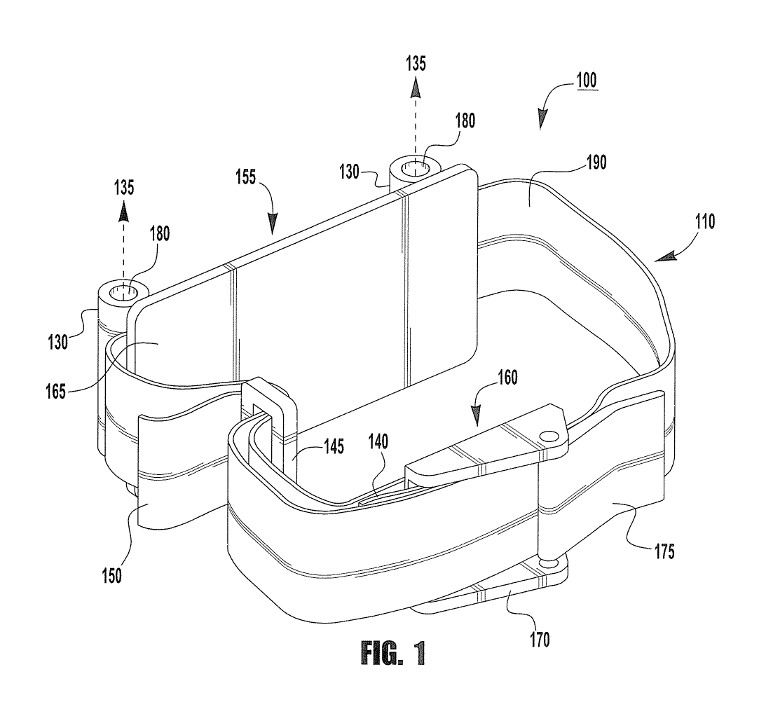

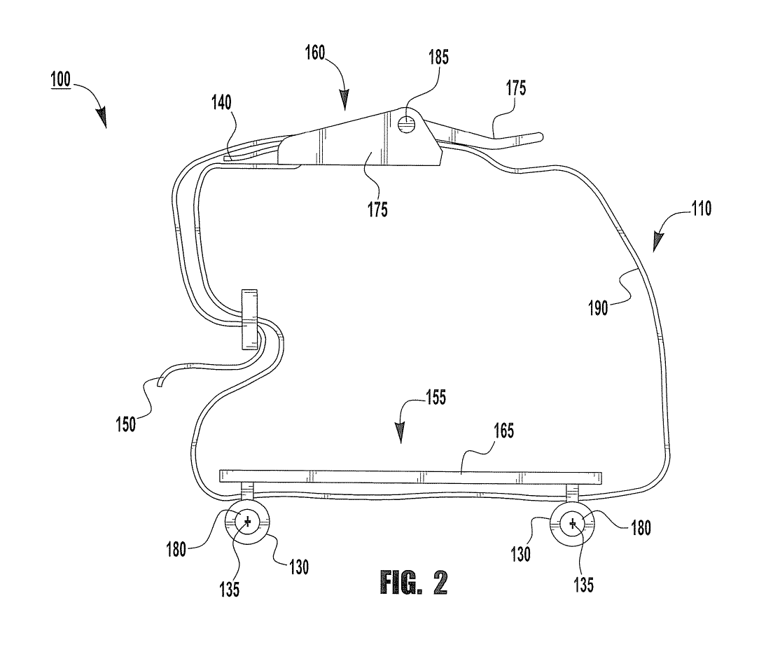

In one embodiment of the application, as shown in FIGS. 1 and 2, the mounting device 100 comprises a strap 110, a latching mechanism 160, and a sleeve 155 having an inner portion 165 and a receiving portion 130. While the strap 110 may be provided in an elastic material, such as rubber, the embodiment of FIGS. 1 and 2 contemplates use of a less elastic material, such as canvas or nylon, or other strong, resilient material made of natural or synthetic fibers. The strap 110 may be provided in varying widths and/or thicknesses, as appropriate for the specific application. Further, while the strap 110 may be generally flat and ribbon-like, as shown in the illustrated embodiment, the strap 110 may also be cylindrical or tubular, or rope-like, or have any other shape or configuration suitable for mounting to a structure. The latching mechanism 160 may be a buckle, latch, hook and loop, Velcro, or any other connection suitable for latching the strap 110 around a structure.

In the exemplary embodiment shown in FIGS. 1 and 2, the strap 110 and latching mechanism 160 provide a securing means for mounting the device 100 to the structure. According to the depicted embodiment, a first end 140 of the strap is fastened to the frame 170 of the latching mechanism 160. The latching mechanism 160 may be provided in one of many suitable materials, including plastics and metals. While the first end 140 of the strap 110 may be secured by folding the end 140 over a slot in the latching mechanism 160 frame and sewing the strap 110 portions together, other means may be used to attach the strap 110 to the latching mechanism 160, such as, for example, rivets, adhesives, or other fasteners. In the illustrated embodiment, the second end 150 or loose end of the strap 110 is permitted to slide through an opening or slot in the latching mechanism 160, and a hinged tongue 175 of the latching mechanism 160 may be tightened against the strap 110 to secure the device 100 around a structure at the desired size and tightness. Additionally, a loop 145 or loops may be provided on the strap 110 to hold the loose end 150 of the strap 110 to the device 100, to prevent the loose end 150 from dangling from the device 100. Other styles of buckles or latches, as used with existing adjustable belts, may also be used to tighten and secure the device 100 of the present application around a structure. As the device 100 of this embodiment is adjustable in size and shape, the device 100 may be used with structures of widely varying sizes and cross-sectional shapes.

In the exemplary embodiment shown in FIGS. 1 and 2, the inner portion 165 of the sleeve 155 provides a gripping means for resisting the movement of the device 100 relative to the structure. In the depicted embodiment, the inner portion 165 of the sleeve 155 contacts and grips the structure when the device 100 is assembled and attached. The inner portion 165 of the sleeve 155 may be made out of any type of material that will increase the friction between the inner portion 165 and the structure, such as rubber or plastic, thereby resisting movement of the device 100 relative to the structure. In addition, the inner portion 165 may be constructed of material that is flexible enough to bend to conform to the adjoining stricture surface, thus increasing the friction between the inner member 165 and the surface of the structure. While the inner portion 165 of the sleeve 155 of FIGS. 1 and 2 is shown as a generally flat member, the inner portion 165 may also be contoured to mate with the adjoining structure surface.

In addition, or in the alternative, the inner portion 165 of the sleeve 155 may have projections (not shown), such as a knurled surface, and/or an adhesive that increases friction between the inner portion 165 and the structure, thereby resisting movement of the device 100 relative to the structure. However, any suitable method of increasing the friction between the inner portion 165 of the sleeve 155 and the structure may be used, such as coating the inner portion 165 of the sleeve 155 with a substance that increases the frictional coefficient.

In addition, or in the alternative, a plate (not shown) may be attached to the inner portion 165 of the sleeve 155. The plate may be connected to the inner portion 165 through the use of a snap-fit arrangement around the inner portion 165 of the sleeve 155. Other means of attachment to other portions of the device 100 may also be used, such as with adhesives or fasteners.

Similar to the inner portion 165 of the sleeve 155, the plate may be made out of a type of material that will increase the friction between the plate and the structure, such as rubber or plastic, thereby resisting movement of the device 100 relative to the structure. The plate may also be made of flexible material that provides additional grip between the plate and the structure by conforming to the adjoining structure surface. The plate may also be contoured to mate with the adjoining structure surface. In addition, or in the alternative, the plate may have projections, such as a knurled surface, and/or an adhesive that increases friction between the plate and the structure, thereby resisting movement of the device 100 relative to the structure. However, any suitable method of increasing the friction between the plate and the structure may be used.

The inner surface 190 of the strap 110 may also be made of a material that increases friction between the strap 110 and the structure, thereby resisting the movement of the device 100 relative to the structure. In addition, flexible plates (not shown), similar to those described above, may be attached to the inner surface 190 of the strap 110. Any suitable means of attachment, such as fasteners, stitching, or adhesives, may be used. These plates may increase the friction between the strap 110 and the structure, thereby resisting movement of the device 100 relative to the structure. In addition, or in the alternative, the inner surface 190 of the strap 110 may have projections, such as a knurled surface, and/or an adhesive or other coating that increases friction between the strap 110 and the structure, thereby resisting movement of the device 100 relative to the structure. However, any suitable method of increasing the friction between the strap 110 and the structure may be used.

In the exemplary embodiment shown in FIGS. 1 and 2, the receiving portions 130 of the sleeve 155 provide a means for attaching decor to the structure. One or more sleeves 155 may be provided on the device 100 for attachment of articles to the device 100. In the embodiment of FIGS. 1 and 2, the strap 110 is disposed through the sleeve 155 (best shown in FIG. 2). The sleeve 155 includes a receiving portion 130, which may be provided with one or more mounting holes 180 for insertion of a pin, fastener or other implement attached to an article to be mounted. The mounting holes 180 may be various sizes and shapes. The receiving portion 130 of the sleeve 155 may be made out of any material suitable for supporting the article to be mounted. The sleeve 155 may be free to slide along the strap 110 to allow positioning of the sleeve 155 on the strap 110, or the sleeve 155 may be affixed to a specific location on the strap 110. While the longitudinal axes 135 of the mounting holes 180 of the embodiment of FIGS. 1 and 2 are oriented to be generally parallel to the longitudinal axis (not shown) of the structure to which the strap 110 is to be assembled, holes of varying orientations may be used. The mounting holes 180 may, for example, be provided with internal threading or an internal diameter adapted to provide a snug or interference fit with the corresponding fastener, in order to secure the article to the device 100. Alternatively, other mounting mechanisms may be provided with the sleeve 155 on the device 100, such as, for example, latches, hooks, loops, or clips.

In alternative embodiments, the sleeve 155 may be attached to the strap 110 through other arrangements, such as, for example, by attaching the sleeve 155 directly to an external surface of the strap 110 or latching mechanism 160 through the use of adhesives, fasteners, stitching or other suitable means, or by providing an insert or multiplier having a connection or connections that engage with a latching mechanism 160 on the strap 110. However, it should be understood that the mounting mechanism does not have to be a sleeve and does not have to surround the strap 110.

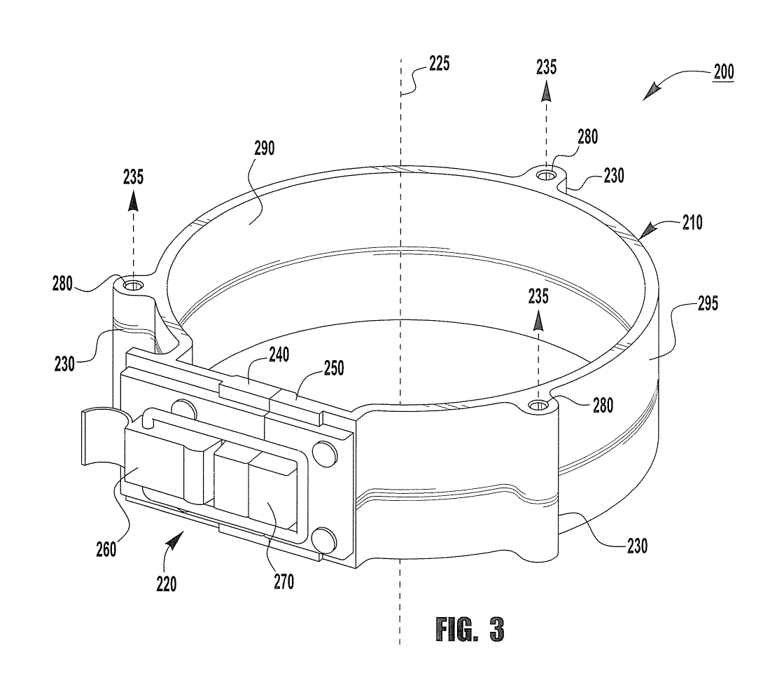

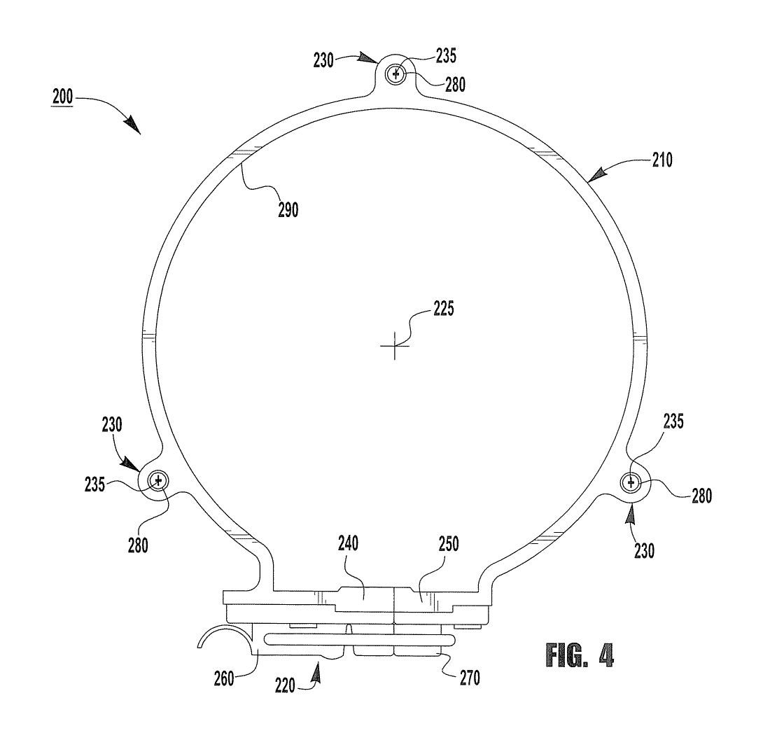

In another embodiment, as shown in FIGS. 3 and 4, the mounting device 200 comprises a flexible, generally cylindrically shaped collar 210 having three ribbed portions 230 and a latching mechanism 220. The collar 210 may be provided in varying widths and/or thicknesses, as appropriate for the specific application. Further, while the collar 210 may be generally flat and ribbon-like, as shown in the illustrated embodiment, the collar 210 may also be cylindrical or tubular, or rope-like, or have any other shape or configuration suitable for the application. In the depicted embodiment, two ends 240, 250 of the collar 210 are joined by the latching mechanism 220. The latching mechanism 220 may be a buckle, latch, hook and loop, or any other connection suitable for latching the collar 210 around a structure.

In the exemplary embodiment shown in FIGS. 3 and 4, the collar 210 and latching mechanism 220 provide a securing means for mounting the device 200 to the structure. The elastic material of the collar 210 permits the ends 240, 250 of the collar 210 to be pulled apart enough to dispose the collar 210 around the structure. Any suitable elastic material, such as rubber, bungee cord, or plastic, will work. In addition, the collar 210 may be hinged to permit the ends 240, 250 to be pulled apart. According to the depicted embodiment, the collar 210 has a substantially fixed length that is adapted to receive structures of substantially the same size and cross-section. However, the elasticity of the collar 210 material may accommodate deviations in the structure shape and size. In addition, in certain embodiments, the collar 210 ends 240, 250 are not connected by a latching mechanism. Instead, the collar is unitary and the elastic material allows it to slide over the structure.

In one embodiment, inserts (not shown) may be used when the collar 210 is applied to a structure having a smaller diameter, thereby providing a snug fit between the collar 210 and the structure. Alternatively, extenders (not shown), which may be provided with latch or buckle type connections, may be assembled between the ends 240, 250 of the collar 210 to allow the belt to be fastened around a structure having a larger diameter. In the embodiment of FIGS. 3 and 4, the latch members 260, 270 are fastened or adhered to external surfaces of the collar ends 240, 250. As such, the ends 240, 250 of the collar 210 may, but need not, be provided with substantially flat surfaces to accommodate the attachment of the latch members 260, 270 to the collar ends 240, 250.

In the exemplary embodiment shown in FIGS. 3 and 4, the collar 210 also provides a gripping means for resisting the movement of the device 200 relative to the structure. The elastic material increases the amount of friction between that collar 210 and the surface of the structure, thereby resisting the movement of the device 200 relative to the structure. However, any suitable material capable of increasing the friction between the collar 210 and the structure may be used. In addition, or in the alternative, the inner surface 290 of the collar 210 may have projections, such as a knurled surface, and/or an adhesive that increases friction between the collar 210 and the structure, thereby resisting movement of the device 200 relative to the structure. However, any suitable method of increasing the friction between the collar 210 and the structure may be used.

The collar 210 of the exemplary mounting device 200 shown in FIGS. 3 and 4 also has ribs 230. These ribbed portions 230 provide a means for attaching decor to the structure. The collar 210 may be provided with one or more ribs 230 or other such protrusions around the external surface 295 of the collar 210 for mounting articles to the collar 210. In the embodiment of FIGS. 3 and 4, three ribs 230 are provided approximately evenly spaced around the periphery of the collar 210.

The ribs 230 of the exemplary mounting device 200 are provided with one or more mounting holes 280 for insertion of a pin, fastener or other implement attached to an article to be mounted. The mounting holes 280 may be various sizes and shapes. The longitudinal axes 235 of the mounting holes 280 are generally parallel to the central opening of the collar 210 and the longitudinal axis 225 of the structure to which the device 200 is mounted. The mounting holes 280 may run the entire length of each rib 230, providing openings at both ends of the rib 230. Alternatively, the mounting holes 280 may extend only partially into the rib 230, thereby providing an opening at only one end of the rib 230.

Each of the ribs 230 and corresponding mounting holes 280 may be adapted for insertion of a fastener, prong, or other such implement, attached to the article to be mounted. While the longitudinal axes 235 of the mounting holes 280 are oriented to be generally parallel to the longitudinal axis 225 of the structure to which the collar 210 is to be assembled, holes of varying orientations may be used. The mounting holes 280 may also be provided with internal threading or an internal diameter adapted to provide a snug or interference fit with the corresponding fastener, in order to secure the article to the collar 210. Alternatively, other mounting mechanisms may be provided on the collar 210, such as, for example, latches, hooks, loops, or clips. These mounting mechanisms may also be used as a means for attaching decor to the structure.

According to another embodiment, a kit may be provided with one or more of any of the above collars, straps, latching mechanisms, sleeves, flexible gripping plates, as described in any of the above embodiments, either disassembled or in some pre-assembled condition, for providing an adaptable mounting device for assembling articles of varying number, size, and shape to structures of varying size and shape in a variety of orientation. By providing interchangeable straps, collars, and related mounting accessories, one kit may be used to provide a means for mounting one or more of many types of articles to many types of structures.

Accordingly, in one aspect of the application, a mounting device for mounting a decor article to a structure. The mounting device includes a strap having a first end and a second end. A latching mechanism is connected to the first end of the strap, the latching mechanism having a slot for passably receiving the second end of the strap therethrough, and a tongue for releasably securing a portion of the strap to the latching mechanism. A sleeve is disposed around the strap, the sleeve having a rigid receiving portion with at least one mounting hole for mounting the article to the receiving portion. The sleeve also includes a flexible plate, connected an inner portion of the sleeve and adapted to grip a mating surface of the post.

In another aspect of the application, a mounting device is provided for mounting a decor article to a structure. The mounting device includes a collar, having a first end, a second end, and at least one protrusion extending from an external surface of the collar. A first latch member is connected to the first end of the collar, and a second latch member is connected to the second end of the collar. The second latch member is adapted to releasably engage the first latch member to position the collar around the post. The protrusion or protrusions each include a mounting hole for mounting the article to the mounting device.

While particular embodiments of the subject application have been described, it will be obvious to those skilled in the art that various changes and modifications of the subject application can be made without departing from the spirit and scope of the application. In addition, while the present application has been described in connection with certain specific embodiments thereof, it is to be understood that this is by way of illustration and not by way of limitation.

We claim:

1. A mounting device for mounting a decor article to a structure, comprising:
a means for securing the mounting device to the structure;
a means for gripping a portion of the structure to resist the movement of the mounting device relative to the structure; and
a means for attaching the décor article to the securing means.

2. The mounting device of claim 1, wherein the securing means comprises a strap portion.

3. The mounting device of claim 2, wherein the gripping means comprises a sleeve that is operative to freely slide relative to the strap portion to allow for positioning of the sleeve relative to the strap portion.

4. The mounting device of claim 2, wherein the gripping means comprises a sleeve that is permanently fixed relative to the strap portion by at least one of an adhesive, a fastener, or stitching.

5. The mounting device of claim 2, wherein the length of the strap portion is adjustable.

6. The mounting device of claim 2, wherein the strap portion is substantially flat.

7. The mounting device of claim 2, wherein the strap portion comprises an elastic material.

8. The mounting device of claim 2, wherein an inner surface of the strap portion comprises a knurled surface.

9. The mounting device of claim 2, wherein at least one end of the strap portion is attached to a latching mechanism.

10. The mounting device of claim 9, wherein the latching mechanism further comprises an adjustable tongue movable between an open position and a closed position for selectively clamping the strap portion within the latching mechanism.

11. The mounting device of claim 1, wherein the securing means comprises a collar and a latching mechanism.

12. The mounting device of claim 1, wherein the attaching means is rigid.

13. The mounting device of claim 1, wherein the attaching means comprises a sleeve having a receiving portion.

14. The mounting device of claim 13, wherein the receiving portion comprises at least one mounting hole.

15. The mounting device of claim 14, wherein the mounting hole is cylindrical.

16. The mounting device of claim 14, wherein the longitudinal axis of the mounting hole is substantially parallel to the longitudinal axis of the structure to which the device is mounted.

17. The mounting device of claim 14, wherein the mounting hole is threaded.

18. The mounting device of claim 1, wherein the gripping means comprises a material capable of resisting the movement of the device relative to the structure.

19. The mounting device of claim 18, wherein the gripping means comprises a flexible material.

20. The mounting device of claim 18, wherein the material is elastomeric.

21. The mounting device of claim 18, wherein the material is plastic.

22. The mounting device of claim 1, wherein the gripping means comprises a knurled surface.

23. The mounting device of claim 1, wherein the gripping means comprises a portion that is adapted to conform to a surface of the structure to which the device is mounted.

24. The mounting device of claim 1, wherein the gripping means comprises a plate portion.

25. The mounting device of claim 24, wherein the plate portion is attached to an inner portion of a sleeve.

26. The mounting device of claim 25, wherein the plate portion is connected to the inner portion of the sleeve by a snap-fit connection.

27. The mounting device of claim 25, wherein the plate portion is attached to the inner portion of the sleeve by at least one of an adhesive or a fastener.

28. The mounting device of claim 1, wherein at least two of the securing means, the gripping means, or the attaching means are combined together in a unitary construction.

29. The mounting device of claim 1, wherein the securing means comprises:
a strap having a first end and a second end; and
a latching mechanism attached to the first end of the strap, wherein the latching mechanism has a slot for passably receiving the second end of the strap there through and a tongue for releasably securing a portion of the strap to the latching mechanism.

30. The mounting device of claim 1, wherein the gripping means comprises:
a strap; and
a sleeve disposed around the strap, wherein the sleeve has a flexible plate attached to an inner portion of the sleeve, wherein the flexible plate is adapted to grip a mating surface of the structure.

31. The mounting device of claim 1, wherein the gripping means comprises:
a strap; and
a sleeve disposed around the strap, wherein the sleeve has a rigid receiving portion with at least one mounting hole for mounting the article to the receiving portion.

32. A mounting device for mounting a decor article to a structure, comprising:
a strap having a first end and a second end;
a latching mechanism attached to the first end of the strap, wherein the latching mechanism has a slot for passably receiving the second end of the strap there through and a tongue for releasably securing a portion of the strap to the latching mechanism; and
a sleeve disposed around the strap, wherein the sleeve has a rigid receiving portion with at least one mounting hole for mounting the article to the receiving portion and a flexible plate attached to an inner portion of the sleeve and adapted to grip a mating surface of the structure.

33. A mounting device for mounting a decor article to a structure, comprising:
a collar having a first end, a second end, and at least one protrusion extending from an external surface of the collar, wherein the at least one protrusion has at least one mounting hole for mounting the article to the mounting device;
a first latch member attached to the first end of the collar; and
a second latch member attached to the second end of the collar, wherein the second latch member is adapted to releasably engage the first latch member to position the collar around the structure.
